(19) United States
(12) Patent Application Publication
(10) Pub. No.: US 2025/0156207 A1
(43) Pub. Date: May 15, 2025

(54) DETECTING ANOMALOUS BEHAVIOR IN A CLOUD COMPUTING ENVIRONMENT

(71) Applicant: Microsoft Technology Licensing, LLC, Redmond, WA (US)

(72) Inventors: Ron KELLER, Ramat Hasharon (IL); Idan HEN, Tel Aviv (IL); Amit Magen MEDINA, Netanya (IL)

(21) Appl. No.: 18/509,287

(22) Filed: Nov. 14, 2023

(51) Int. Cl. G06F 9/455

(52) U.S. Cl. CPC G06F 9/45558; G06F 2009/45587

(57) ABSTRACT

Described herein are technologies related to analyzing behavioral data of an entity in a cloud computing environment and determining suitability of providing the behavioral data to a computer-executable model that is configured to identify anomalous behavior of the entity. The technologies described herein improve performance of computer-executable models that are configured to detect anomalous behavior in a cloud computing environment.

### BACKGROUND

Cloud computing environments offer a variety of computing services to customers of the cloud computing environments. In an example, a cloud computing environment can offer compute services, database services, storage services, software as a service (Saas), platform as a service (PaaS), infrastructure as a service (IaaS), etc. For instance, a cloud computing environment can offer tens to thousands of different computing-related services to customers of the cloud computing environment. Further, a cloud computing environment can support several different programming languages, programming tools, and programming frameworks.

Moreover, a cloud computing environment can include data centers geographically dispersed in a country or across counties and can employ large-scale virtualization at these data centers. A cloud computing environment often provides services to numerous customers and, to that end, can execute virtual machines, containers, etc. on hardware resources of the cloud computing environment.

In addition, cloud computing environments offer security functionality to customers who use such environments for services provided by the cloud computing environments. In connection with providing security functionality, behavior of an entity corresponding to the cloud computing environment can be modeled through use of a computer-executable model, thereby allowing for the computer-executable model to be used to detect anomalous behavior of the entity (where anomalous behavior may indicate occurrence of a cyber-attack by a malicious attacker or may indicate some other security threat). An entity, as the term is used herein, can be or include a virtual machine, a container, a hardware processor, computer readable data storage, or other suitable entity. Therefore, an entity may represent a customer of the cloud computing environment, a virtual machine that is executed by the cloud computing environment on behalf of the customer, or the like.

In regard to the computer-executable model, such model is trained based upon data that is representative of observed, baseline behavior of the entity over time; after being trained, the computer-executable model can be provided with behavioral data that is representative of recent behavior of the entity (e.g., a most recent hour), and the computer-executable model can output an indication as to whether the behavior data is anomalous based upon the behavioral data provided to the computer-executable model. When the computer-executable model outputs an indication that the behavioral data is anomalous, an alert can be generated and provided to a computing device of a customer of the cloud computing environment that corresponds to the entity, thus informing the customer of the anomalous behavior of the entity.

It has been observed, however, that data that is representative of behavior of entities in a cloud computing environment can be noisy. When a computer-executable model is trained based upon noisy data, the computer-executable model may incorrectly identify recent behavioral data of the entity as being anomalous, resulting in transmittal of false alarms to the customer. Provision of numerous false alarms to the customer is problematic, as the customer may begin to ignore alarms provided thereto by the cloud computing environment. Further, behavioral data of the entity is typically analyzed by the cloud computing environment relatively frequently (e.g., once an hour), and it is impractical to repeatedly retrain the computer-executable model in connection with identifying anomalous behavior of the entity, as behavioral data is continuously generated with respect to the entity.

### SUMMARY

The following is a brief summary of subject matter that is described in greater detail herein. This summary is not intended to be limiting as to the scope of the claims.

Described herein our various technologies pertaining to detection of anomalous behavior with respect to an entity in a cloud computing environment. As noted above, the entity can be or include a virtual machine, a container, a hardware processor, computer readable storage, or any suitable combination thereof. Therefore, in an example, the entity includes several virtual machines and several containers that correspond to a customer of the cloud computing environment.

As noted above, a problem associated with detecting anomalous behavior of an entity in a cloud computing environment is that a computer-executable models that is configured to identify anomalous behavior may be trained based upon noisy data; in addition, behavioral data corresponding to an entity may also be noisy. Therefore, the computer-executable model may improperly generate an output that indicates that recent behavioral data is anomalous (i.e., a false positive), when in actuality the recent behavioral data is noisy but not anomalous. Therefore, an alert should not be provided to the customer.

The technologies described herein address this problem by analyzing recent behavioral data of an entity prior to such data being provided to a computer-executable model and refraining from providing the recent behavioral data to the computer-executable model when the recent behavioral data is not suitable for provision to the model. With more particularity, the computer-executable model is trained to identify anomalous behavior based upon values of features corresponding to the entity over a period of time. Example features include “process name”, “parent process”, “working directory”, amongst others. Therefore, values of the feature “process name” can be names of processes executed by or on behalf of the entity, such as “process 1”, “process 2”, or other suitable process name. Similarly, values of the feature “parent process” can be names of processes that are parents of processes executed by or on behalf of the entity, such as “parent process 1”, “parent process 2”, etc. A source of behavioral data of the entity, such as a log file, a trace file, a data stream, or other suitable source that identifies behavior of the entity (including names of processes executed by the entity, working directories associated with the entity, and so forth) is obtained, and values of features that are to be provided as input to the computer-executable model are extracted from the source of the behavioral data. A metric value that is indicative of suitability of the behavioral data for provision to the computer-executable model is computed, and a determination is made as to whether to provide the behavioral data to the computer-executable model.

In more detail, the cloud computing environment is configured to construct time-series data for each feature used by the computer executable model to detect anomalous behavior of the entity. The time-series data for a feature includes values assigned to numerous time periods in a window of time. For instance, the window of time is 24 hours, the time periods are one hour, and each one hour time period is assigned a value. A value assigned to a time period in the time-series data indicates a number of values of the feature that occurred in the time period but that did not occur in any previous time periods in the window of time. For example, with respect to the feature “process name”, during a first time period (i.e., at the beginning of the window of time), process P1 was executed by or on behalf of the entity three times, process P2 was executed by or on behalf of the entity twice, and process P3 was executed by or on behalf of the entity seven times. Accordingly, the value in the time-series data assigned to the first time period is 3, as process P1, process P2, and process P3 were each executed by or on behalf of the entity during the first time period but were not executed by or on behalf of the entity in any previous time periods in the window of time. Continuing with the example, during a second time period that immediately follows the first time period, process P2 was executed by or on behalf of the entity once, process P3 was executed by or on behalf of the entity five times, process P4 was executed by or on behalf of the entity once, and process P5 was executed by or on behalf of the entity six times. A value assigned to the second time period in the window of time is 2, as processes P2 and P3 were executed previously in the window of time (during the first time period), while processes P4 and P5 were executed for the first time in the window of time during the second time period. Therefore, the time-series data for the feature “process name” includes, for each time period in the window of time, the number of process names that were first seen in the window of time during the time period.

The above-mentioned metric value is computed based upon the different time-series data for the features referenced above. With more particularity, a confidence value and a trend value are computed for a feature based upon the time-series data for the feature. The confidence value is computed through a statistical approach (such as exponential smoothing), and the confidence value is indicative of a confidence that a next value in the time-series-data can be accurately predicted based upon the previous values in the time-series data. The trend value is indicative of a trend (linear or exponential) of values in the time-series data for the feature. In addition, the metric value can be further based upon a weight (importance) assigned to the feature by the computer executable model (e.g., a hyperparameter of the computer-executable model assigned to the feature). Again, the computed metric value is indicative of suitability of the behavioral data for provision to the computer-executable model.

Therefore, the cloud computing environment can ascertain whether to provide the behavioral data of the entity to the computer-executable model based upon the metric value. When the metric value is too low, the cloud computing environment can refrain from providing behavioral data of the entity to the computer-executable model. When, however, the metric value is sufficiently high, the behavioral data is provided to the computer-executable model, and the computer-executable model can output an indication as to whether the behavioral data of the entity is anomalous. The technologies described herein result in improved performance of computer-executable models that are trained to detect anomalous behavior, as the computer-executable models generate fewer false positives (as such models are not provided with behavioral data that is likely to cause the computer-executable model to generate false positives). Moreover, the technologies described herein execute continuously in a cloud computing environment, and accordingly the computer-executable models are provided with behavioral data of entities when appropriate.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a functional block diagram of a cloud computing environment that is configured to detect anomalous behavior of an entity associated with the cloud computing environment.

FIG. 2 is a schematic that illustrates behavioral data of an entity with respect to a feature.

FIG. 3 is a schematic that illustrates time-series data generated based upon the behavioral data depicted in FIG. 2.

FIG. 4 is a functional block diagram of a metric computer module that is configured to compute a metric value based upon time-series data corresponding to features employed by a computer executable model when ascertaining whether behavioral data of an entity is anomalous.

FIG. 5 is a flow diagram that illustrates a method for providing behavioral data to a computer-executable model, where the computer-executable model is configured to identify anomalous behavior of an entity in a cloud computing environment based upon the behavioral data.

FIG. 6 is a flow diagram that illustrates a method for generating time-series data for a feature that corresponds to an entity.

FIG. 7 a flow diagram that illustrates a method for computing a metric value that corresponds to behavioral data of an entity, where the metric value is indicative of suitability of the behavioral data for provision to a computer-executable model, and further where the computer-executable model is configured to ascertain whether the behavior data is anomalous (relative to baseline behavior of the entity).

FIG. 8 depicts an example computing system.

### DETAILED DESCRIPTION

Various technologies pertaining to identifying anomalous behavior in a cloud computing environment are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component,” “module,” and “system” are intended to encompass computer-readable data storage that is configured with computer-executable instructions that cause certain functionality to be performed when executed by a processor. The computer-executable instructions may include a routine, a function, or the like. It is also to be understood that a component, module, or system may be localized on a single device or distributed across several devices.

Described herein are various technologies generally pertaining to a cloud computing environment, and more specifically pertaining to detection of anomalous behavior by an entity in the cloud computing environment. The cloud computing environment can include network-connected data centers and hardware and software associated therewith. Therefore, the cloud computing environment can include racks of server computing devices, edge routers, switches, etc. The cloud computing environment can provide services to multiple customers, where such services can include compute services, storage services, database services, SaaS, PaaS, IaaS, and/or other suitable services. A customer of the cloud computing environment can be associated with an entity. In an example, the entity can represent hardware and software of the cloud computing environment that is assigned to a customer. Therefore, the entity can be or include a hardware processor, computer readable storage, a virtual machine (and hardware and software associated with the virtual machine), a container (and hardware and software associated with the container), etc. In another example, the entity may be an application that is executed on behalf of the customer. Generally, the entity can be any suitable type of entity whose behavior in the cloud computing environment is desirably monitored.

In connection with detecting anomalous behavior of an entity, the cloud computing environment executes a computer-executable model that is trained to identify anomalous behavior of the entity. Anomalous behavior can refer to executing a process that is not typically executed by the entity, executing a process a number of times over some time period (where the number of times that the process is executed is anomalous relative to baseline behavior of the entity), accessing a directory that is typically not accessed by or on behalf of the entity, and so forth. The computer-executable model is trained to identify anomalous behavior associated with the entity based upon values of features corresponding to the entity. Features contemplated by the computer-executable model when identifying anomalous behavior of an entity are typically identified by security experts and can include any number of different types of features. Example features include names of processes executed by or on behalf of the entity, names of parents of processes that are executed by or on behalf of the entity, names of directories accessed by or on behalf of the entity, numbers of processing cycles utilized when executing a process or thread by or on behalf of the entity, amount of computer readable storage consumed by data stored by or on behalf of the entity, and so forth.

Because behavioral data corresponding to an entity can be noisy, computer-executable models have been observed to output false positives with respect to anomalous behavior when provided with behavioral data as input. The technologies described herein are configured to identify behavioral data corresponding to an entity that is likely to cause the computer-executable model to incorrectly classify input behavior data as anomalous. Behavioral data corresponding to an entity can be any suitable data that can be extracted from or derived from instrumentation data (such as a log file, a trace, a data stream output by or on behalf of the entity, etc.). With more particularity, and as will be described in greater detail herein, the cloud computing environment can construct time-series data corresponding to a feature that is associated with the entity, where the time-series data identifies, for each time period in a window of time that includes several time periods, a number of occurrences of values of the feature that have not been previously observed within the window of time. Therefore, with respect to a time period, a value in the time-series data can identify a number of values of the feature that have not previously been observed with respect to the entity in the window of time. A metric value is computed based upon the time-series data, where the metric value is indicative of indicative of suitability of the behavioral data for provision to a computer-executable model that is configured to identify anomalous behavior of the entity. In other words, the metric value is indicative of a likelihood that the computer-executable model will output a false positive when provided with the behavioral data as input. Therefore, based upon the metric value, a decision is made as to whether to provide the behavioral data as input to the computer-executable model.

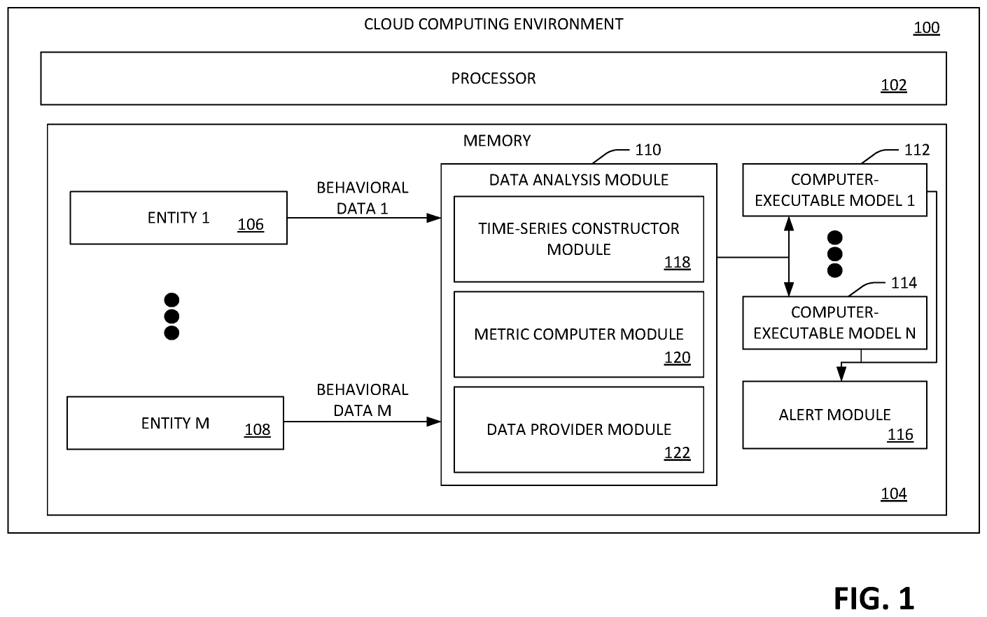

With reference now to FIG. 1, a functional block diagram of a cloud computing environment 100 is depicted. As described previously, the cloud computing environment 100 can include at least one data center, and therefore includes hardware and software associated with a data center. In FIG. 1, the cloud computing environment 100 is abstracted; it is to be understood, however, that the cloud computing environment 100 is a complex system of hardware and software that is configured to provide services to customers of the cloud computing environment 100.

The cloud computing environment 100 includes a processor 102 and memory 104, where the processor 102 executes instructions that are stored in the memory 104. In addition, the memory 104 includes representations of several entities 106-108. An entity can be or include hardware, software, or a combination thereof. In an example, the first entity 106 is or includes a virtual machine. In another example, the mth entity 108 is or includes a container. Therefore, an entity can be any suitable hardware, software, or combination thereof whose behavior is desirably monitored for anomalous behavior.

Each of the entities 106-108 is associated with behavioral data that is representative of behavior of the entities 106-108. Specifically, first behavioral data is associated with the first entity 106 and mth behavioral data is associated with the mth entity 108. Behavioral data is generated as computing operations are performed with respect to the entities 106-108. Thus, in an example, the first behavioral data can include an identity of a process executed by or on behalf of the first entity 106, an identity of a parent of the process executed by or on behalf of the first entity 106, an identity of an amount of computer readable storage consumed by or on behalf of the first entity 106, a number of processor cores employed by or on behalf of the first entity 106 when undertaking a computing operation, and so forth. Behavioral data can be output as actions occur (in a data stream). In another example, behavioral data is extracted from instrumentation data, such as a log file generated by or on behalf of an entity, a trace file, a monitoring file, or the like.

The memory 104 further includes a data analysis module 110 that receives the behavioral data associated with the entities 106-108. As will be described in greater detail below, the data analysis module 110 is configured to compute a metric value for an entity, where the metric value is indicative of suitability of provision of behavioral data to a computer-executable model that is configured to determine whether the behavioral data is anomalous. The memory 104 includes several computer executable models 112-114 that are configured to identify anomalous behavior associated with entities in the cloud computing environment 100. In an example, the first computer-executable model 112 is configured to identify anomalous behavior of the first entity 106, while the nth computer executable model 114 is configured to identify anomalous behavior of the same or different entity. Continuing with this example, the first computer-executable model 112 is configured to receive values of features in the behavioral data corresponding to the first entity 106 and output an indication as to whether the first entity 106 is exhibiting anomalous behavior based upon the values of the features.

The memory 104 further includes an alert module 116 that is in communication with the computer-executable models 112-114. When, for example, the first computer-executable model 112 generates an output that indicates that the first entity 106 is exhibiting anomalous behavior, the alert module 116 can generate and transmit an alert to a computing device operated by a customer of the cloud computing environment 100 that is associated with the first entity 106. Hence, the alert module 116 can inform the customer associated with the first entity 106 that there may be a security threat associated with the first entity 106.

Returning to the data analysis module 110, such module 110 is configured to determine whether to provide behavioral data to one or more of the computer-executable models 112-114. For instance, when the first behavioral data associated with the first entity 106 is noisy, provision of the first behavioral data to the first computer-executable model 112 is likely to result in the first computer-executable model 112 generating an output that incorrectly indicates that the first entity 106 is exhibiting anomalous behavior. The data analysis module 110 is configured to refrain from providing the first behavioral data to the first computer-executable model 112 when, for example, the data analysis module 110 determines that the first computer-executable model 112 is likely to generate a false positive when provided with the first behavioral data.

To that end, the data analysis module 110 includes a time-series constructor module 118, a metric computer module 120, and a data provider module 122. Generally, the time-series constructor module 118 constructs time-series data for the entity 106 based upon content of the first behavioral data (over time). With more specificity, the time-series constructor module 118 is configured to construct a separate time-series for each feature represented in the first behavioral data, where the first computer-executable model 112 generates an output based upon values of the features.

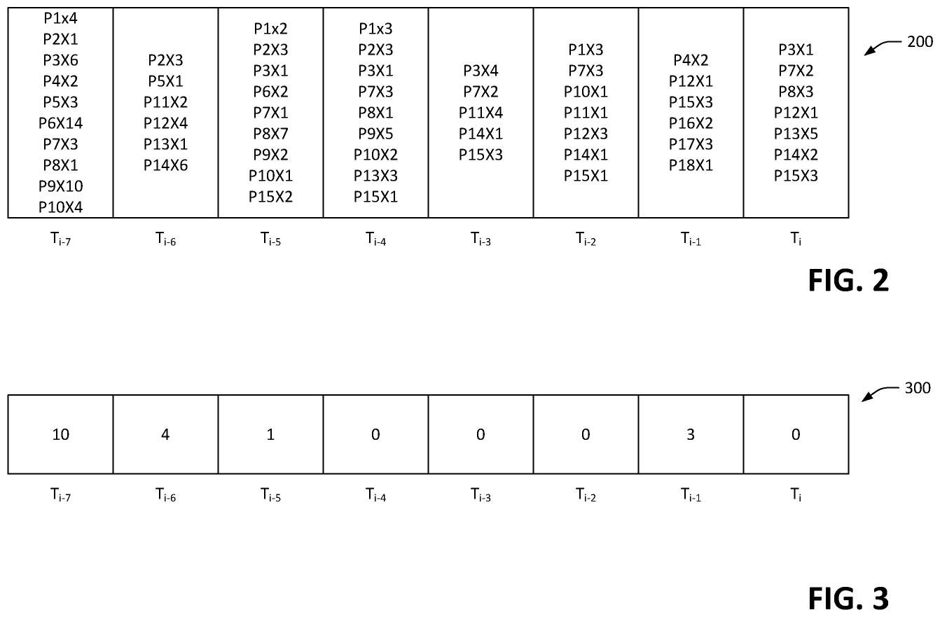

Referring to FIG. 2, an example schematic of a portion of the first behavioral data 200 is presented. The portion of the first behavioral data 200 corresponds to a first feature, the first feature is “process name”, and where a value of the first feature is a name of a process executed by or on behalf of the first entity 106. The portion of the first behavioral data 200 is separated according to time periods in which values of the features were observed over a window of time. In the example behavioral data 200, during a window of time Tᵢ₋₇, process P1 was executed four times, process P2 was executed once, process P3 was executed six times, and so forth. During a next time period (Tᵢ₋₆), process P2 was executed three times, process P5 was executed once, process P11 was executed twice, process P12 was executed four times, and so forth. During the next time period (Tᵢ₋₅), process P1 was executed twice, process P2 was executed three times, process P3 was executed once, and so forth. For sake of brevity process names observed during subsequent time periods in the window of time are not described but are illustrated in FIG. 2. It is further to be understood that the first behavior data can include other portions that include values for other features that are provided to the first computer-executable model 112 as input.

The time-series constructor module 118 constructs time-series data for the feature based upon the portion of the behavioral data 200 that corresponds to the first entity 106. With reference to FIG. 3, time-series data 300 constructed by the time-series constructor module 118 based upon the portion of the behavioral data 200 is presented. For each time period, and as the first behavioral data is received, the time-series constructor module 118 identifies a feature value (process name) in the first behavioral data and ascertains whether the feature value was observed in the behavioral data during a previous time period within the window of time. Therefore, in the time period Tᵢ₋₇, which is at the beginning of the window of time, processes P1-P10 were executed by or on behalf of the first entity 106, and such processes were not executed by or on behalf of the first entity 106 in a previous time period. Therefore, the time-series constructor module 118 assigns a value of 10 to the time period Tᵢ₋₇. For the next time period (Tᵢ₋₆), processes P2 and P5 were executed by or on behalf of the first entity 106. Processes P2 and P5, however, were also executed in a previous time period in the window of time (Tᵢ₋₇). In addition, processes P11-P14 were executed by or on behalf of the first entity 106 during the time period Tᵢ₋₆. Since each of processes P11-P14 were not executed by or on behalf of the first entity 106 in a previous time period, the value of the time-series data 300 for time period Tᵢ₋₆ is set by the time-series constructor module 118 to be 4 (since four process names were observed for the first time in the window of time during time Tᵢ₋₆). Continuing on with respect to the time period Tᵢ₋₅, nine different processes were executed by or on behalf of the first entity 106. Only one of such processes, however, was executed by or on behalf of the first entity 106 for a first time in the window of time (process P15). Accordingly, the time-series constructor module 118 assigns a value of 1 to the time period Tᵢ₋₅.

As noted above, the time-series constructor module 118 updates the time-series data 300 as behavioral data corresponding to the first entity 106 is received. Referring to time period Tᵢ, the behavioral data 200 indicates that process P3 has been executed by or on behalf of the first entity 106 during such time period. The time-series constructor module 118 ascertains that process P3 was executed by or on behalf of the first entity 106 in one of the previous time periods in the window of time, and therefore does not increment a value in the time-series data for time period Tᵢ. The behavioral data 200 further indicates that process P7 was executed by or on behalf of the first entity 106 during time period Tᵢ. The time-series constructor module 118 ascertains that process P7 was executed in a previous time period in the window of time, and therefore again does not increment the value assigned to time period Tᵢ in the time-series data 300. This process repeats until the time period Tᵢ expires. In the example illustrated in FIGS. 2 and 3, the time-series constructor module 118 assigns a value of 0 to time period Tᵢ in the time-series data 300.

As time passes, the time-series constructor module 118 appends a new entry to the time-series data 300. In an example, when the time-series constructor module 118 appends an entry to the time-series data 300, the time-series constructor module 118 can remove the earliest entry in the time-series data 300, such that the time-series data 300 maintains a constant number of entries. Further, each time period can have a same duration. In other examples, however, the time periods in the window of time can have different durations. In summary, then, the time-series data 300 includes a sequence of values that correspond to different time periods, where each value is indicative of a number of feature values that were observed during the time period but where not observed in any previous time periods in the window of time.

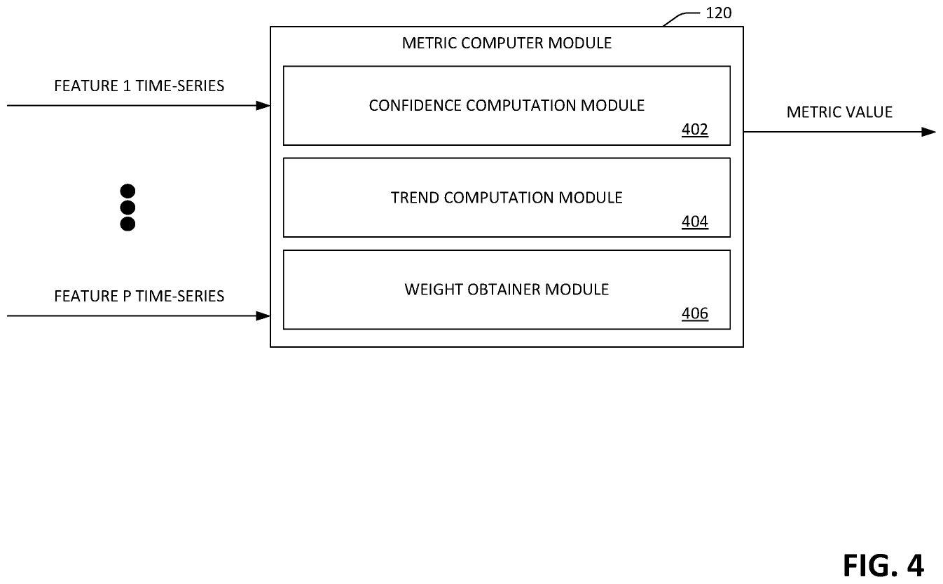

Now referring to FIG. 4, a functional block diagram of the metric computer module 120 is presented. The metric computer module 120 includes a confidence computation module 402, a trend computation module 404, and a weight obtainer module 406. The metric computer module 120 receives time-series data for each feature that has values that can be provided as input to the first computer-executable model 112. For instance, the metric computer module 120 receives feature one (F1) time-series data through feature P (FP) time-series data.

The confidence computation module 402 receives time-series data for a feature for the entity and computes a confidence value that is indicative of a confidence that a next value in the time-series data can be accurately predicted. The confidence value for the time-series is indicative of stability of data in the time-series, and therefore indicative of stability of values of the feature in the behavioral data for the entity. In an example, the confidence computation module 402 can employ exponential smoothing in connection with computing the confidence value for the time-series data. The confidence computation module 402 computes a confidence value for each time-series data received for the first entity 106.

The trend computation module 404 computes a trend value for each time-series data received. The trend value can be or be based upon a linear trend corresponding to the time-series data, an exponential trend corresponding to the time-series data, or the like.

The weight obtainer module 406 obtains weights assigned to values of the feature by the first computer-executable model 112 when the first computer executable model 112 generates an output based upon behavioral data. More specifically, the first computer-executable model 112 assigns a weight to each feature considered by the computer-executable model when identifying anomalous behavior of the first entity 106; such weights are hyperparameters of the first computer-executable model 112 and are obtained by the weight obtainer module 406.

The metric computer module 120 computes a metric value for the first computer-executable model 112 based upon confidence values computed by the confidence computation module 402, trend values computed by the trend computation module 404, and important weights obtained by the weight obtainer module 406. In an example, the metric computer module 120 computes the metric value through use of the following algorithm:

$$Metric Value = ( {C}_{1} * \frac{1}{{C}_{1}^{D}} + {T}_{1} * {W}_{1} ) + ⋯ + ( {C}_{P} * \frac{1}{{C}_{P}^{D}} + {T}_{P} * {W}_{P} )$$

where C is a confidence value computed by the confidence computation module 402, D is a damping value, T is a trend value computed by the trend computation module 404, and W is an importance weight obtained by the weight obtainer module 406. In an example, D=⅓.

While the metric computer module 120 has been described herein as performing various computations in connection with computing the metric value for the first computer executable model 112, it is understood that other approaches are contemplated. For instance, the metric computer module 120 can be a machine learning algorithm that includes, for example, a long short-term memory (LSTM) network, a convolutional neural network, a recurrent neural network, and so forth.

Returning to FIG. 1, the data provider module 122 determines whether to provide the first behavioral data to the first computer-executable model 112 based upon the metric value computed by the metric computer module 120. When the metric value is too low, the data provider module 122 refrains from providing the first behavioral data to the first computer-executable model. Conversely, when the metric value is sufficiently high, the data provider module 122 provides the first behavioral data to the first computer-executable model 112. The first computer-executable model generates an output based upon the first behavioral data, where the output indicates whether or not the first behavioral data is anomalous. The above-described process can be performed periodically (e.g., every time period), and can further be performed for each computer-executable model in the computer-executable models 112-114 (based upon behavioral data corresponding to the entities 106-108).

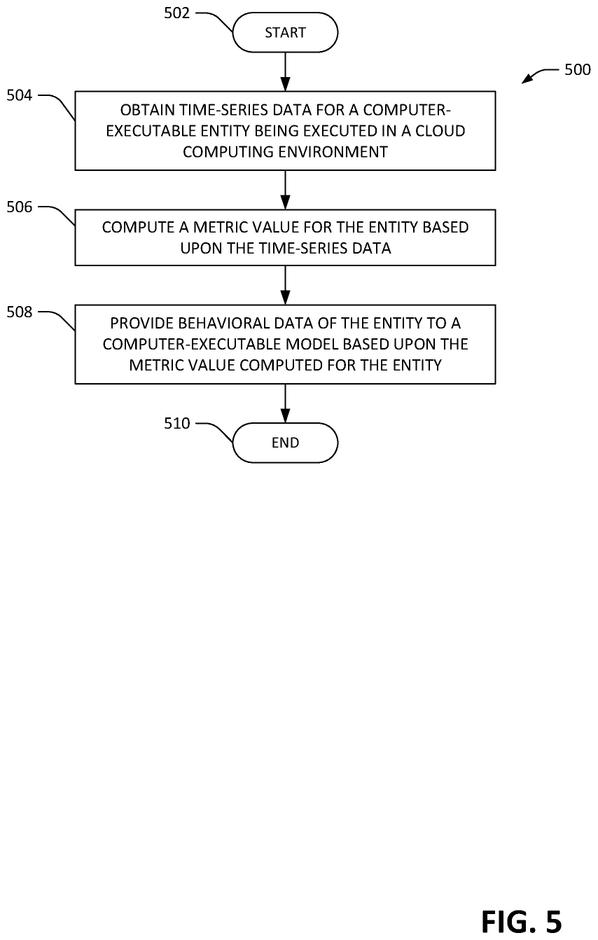

FIGS. 5-7 illustrate methods relating to detection of anomalous behavior. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Now referring solely to FIG. 5, a flow diagram illustrating a method 500 for providing behavioral data for an entity in a cloud computing environment to a computer-executable model that is configured to determine whether or not the behavioral data is anomalous (relative to baseline behavior of the entity). The method 500 starts at 502, and at 504 the time-series data for a computer executable entity being executed in a cloud computing environment is obtained. In an example, the computer-executable entity is or includes a virtual machine, a container, or a combination of virtual machines and containers. The time-series data includes values assigned to time periods over a window of time, where a value assigned to a time period in the window of time is indicative of a number of processes that were executed with respect to a feature of the entity during the time period that were not executed in any previous time periods in the window of time.

At 506, a metric value is computed for the entity based upon the time-series data obtained at 504. As described previously, the metric value is indicative of suitability of the behavioral data for provision to a computer-executable model.

At 508, the behavioral data corresponding to the entity is provided to the computer-executable model. The computer executable model generates an output that indicates whether the behavioral data includes an anomaly. The method 500 completes at 510.

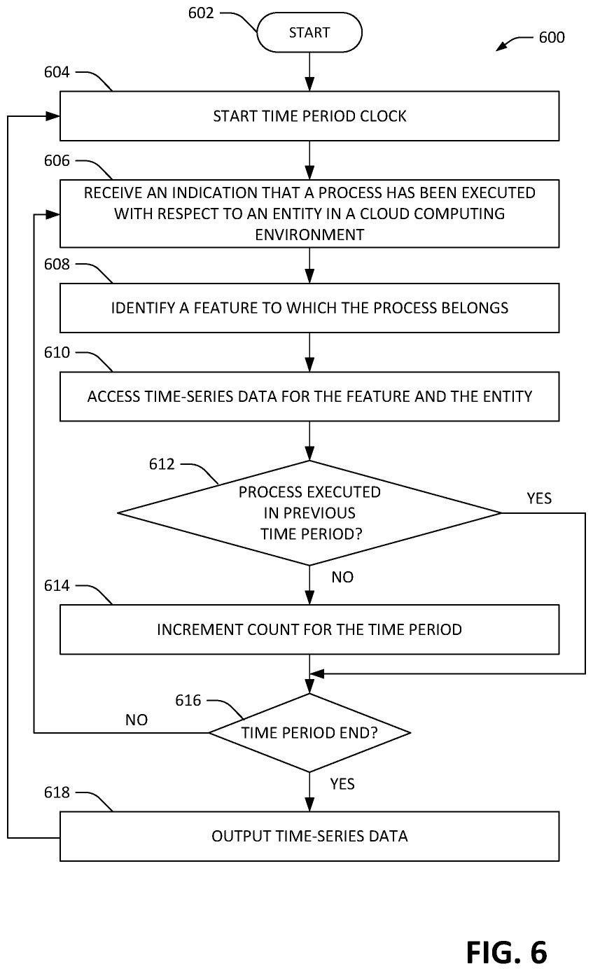

Now referring to FIG. 6, a flow diagram illustrating a method 600 for constructing time-series data for a feature of an entity is presented. The method 600 starts at 602, and at 604 a time period clock is started at the start of a time period. The clock indicates that a new time period has begun.

At 606, an indication is received that a process has been executed with respect to an entity in a cloud computing environment. For example, the indication can be received in a log file, a trace file, a stream of data output by the entity, etc.

At 608, a feature is identified based upon the process, where, for example, a name of the process is a value of the feature. At 610, time-series data for the feature and the entity is accessed. At 612, a determination is made as to whether the process was executed in a previous time period in a window of time. When it is determined at 612 that the process was not executed in connection with the entity in a previous time period in the window of time, then at 614 a value for the time period in the time-series data is incremented. When it is determined at 612 that the process was executed in a previous time period or after the value for the time period has been incremented at 614, the method 600 proceeds to 616, where a determination is made as to whether the time period has ended. When the time period has not ended, the method 600 returns to 606. When it is determined that the time period has ended, the method 600 proceeds to 618, where the time-series data is output. For example, the time-series data is output to the metric computation module 120. The method 600 then returns to 604, where a new time period is started.

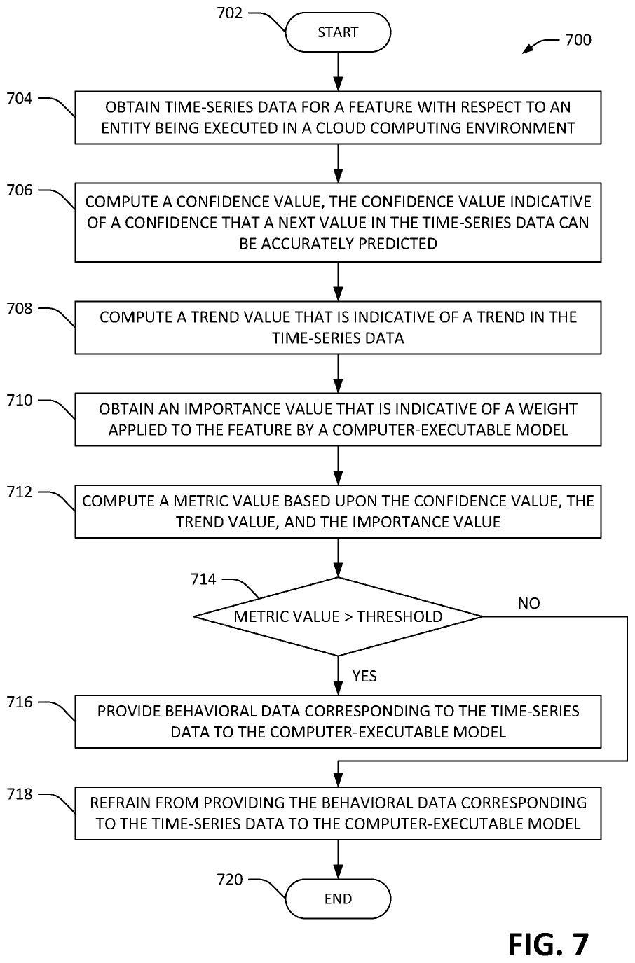

Turning now to FIG. 7, a flow diagram illustrating a method 700 for computing a metric value for an entity is presented, where the metric value is computed based upon behavioral data of the entity. The method 700 starts at 702, and at 704 time-series data for a feature with respect to an entity being executed in a cloud computing environment is received. At 706, a confidence value is computed based upon the time-series data, where the confidence value is indicative of a confidence that a next value in the time-series data can be accurately predicted. At 708, a trend value is computed based upon the time-series data, where the trend value is indicative of a trend in the time-series data.

At 710, an importance value is obtained, where the importance value is indicative of a weight applied to the feature by a computer executable model when the computer executable model identifies anomalous behavior of an entity. At 712, a metric score is computed based upon the confidence value, the trend value, and the importance value. At 714, a determination is made as to whether the computed metric value is greater than a threshold. When it is determined at 714 that the metric value is greater than the threshold, the method 700 proceeds to 716, where behavioral data corresponding to the time-series data is provided to the computer-executable model. When it is determined at 714 that the metric value is not greater than the threshold, the method 700 proceeds to 718, where the behavioral data corresponding to the time-series data is refrained from being provided to the computer-executable model. The method completes at 720.

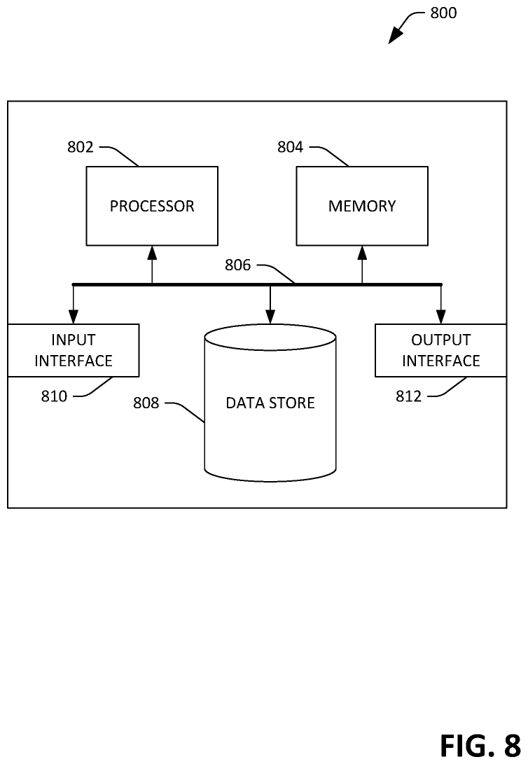

Referring now to FIG. 8, a high-level illustration of an exemplary computing device 800 that can be used in accordance with the systems and methodologies disclosed herein is illustrated. For instance, the computing device 800 may be used in a system that generates time-series data. By way of another example, the computing device 800 can be used in a system that computes a metric value based upon the time-series data. The computing device 800 includes at least one processor 802 that executes instructions that are stored in a memory 804. The instructions may be, for instance, instructions for implementing functionality described as being carried out by one or more components discussed above or instructions for implementing one or more of the methods described above. The processor 802 may access the memory 804 by way of a system bus 806. In addition to storing executable instructions, the memory 804 may also store behavioral data of an entity, time-series data, etc.

The computing device 800 additionally includes a data store 808 that is accessible by the processor 802 by way of the system bus 806. The data store 808 may include executable instructions, time-series data, behavioral data, etc. The computing device 800 also includes an input interface 810 that allows external devices to communicate with the computing device 800. For instance, the input interface 810 may be used to receive instructions from an external computer device, from a user, etc. The computing device 800 also includes an output interface 812 that interfaces the computing device 800 with one or more external devices. For example, the computing device 800 may display text, images, etc. by way of the output interface 812.

It is contemplated that the external devices that communicate with the computing device 800 via the input interface 810 and the output interface 812 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 800 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 800 may be a distributed system. Thus, for instance, several devices may be in communication by way of a network connection and may collectively perform tasks described as being performed by the computing device 800.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Various aspects have been described herein in accordance with at least the following examples.

(A1) In an aspect, a method for determining whether to provide data to a computer-executable model that is trained to identify anomalies in data corresponding to an entity that is executing in a cloud computing environment is described herein. The method includes obtaining time-series data for a feature of the entity, where the feature comprises multiple processes that are executable by the entity. The time-series data includes values assigned to time periods within a time window, where a value in the values is representative of a number of processes in the processes that were executed by the entity a first time within the time window. The method also includes computing a likelihood that a next value in the time-series data for a next time period following the time window is able to be correctly predicted, where the likelihood is computed based upon the values assigned to the time periods. The method further includes providing the data corresponding to the entity to the computer-executable model based upon the likelihood, where the computer-executable model generates an output based upon the data, and further where an alert is transmitted to a computing device associated with the entity based upon the output of the computer-executable model.

(A2) In some embodiments of the method of (A1), the alert indicates that the data corresponding to the entity includes an anomaly.

(A3) In some embodiments of the method of at least one of (A1)-(A2), the method also includes computing a trend value based upon the values assigned to the time periods within the time window, where the data corresponding to the entity is provided to the computer-executable model based further upon the trend value.

(A4) In some embodiments of the method of at least one of (A1)-(A3), the computer-executable entity is a virtual machine executing in the cloud computing environment.

(A5) In some embodiments of the method of at least one of (A1)-(A3), the computer-executable entity is a container executing in the cloud computing environment.

(A6) In some embodiments of the method of at least one of (A1)-(A5), the method also includes obtaining second time-series data for a second feature of the entity, where the second feature comprises second multiple processes that are executed by the entity. The second time-series data includes second values assigned to the time periods within the time window, where a second value in the second values is representative of a second number of second processes in the multiple second processes that were executed by the entity a first time within the time window, where the data corresponding to the entity is provided to the computer-executable model based upon the second time-series data.

(A7) In some embodiments of the method of (A6), the method also includes computing a second likelihood that a next value in the second time-series data for the next time period following the time window is able to be correctly predicted, where the second likelihood is computed based upon the second values assigned to the time periods, and further where the data corresponding to the entity is provided to the computer-executable model based upon the second likelihood.

(A8) In some embodiments of the method of at least one of (A1)-(A7), the method also includes obtaining an importance value for the feature, where the importance value for the feature is indicative of a weight assigned to the feature by the computer-executable model, and further where the data corresponding to the entity is provided to the computer-executable model based upon the importance value.

(B1) In another aspect, a method disclosed herein includes obtaining time-series data for a computer-executable entity that is being executed in a cloud computing environment, where the time-series data is based upon behavioral data for the entity. The time-series data includes values assigned to time periods over a window of time, where a value assigned to a time period in the time periods is indicative of a number of processes that were executed by or on behalf of the computer-executable entity with respect to a feature during the time period that were not executed in any previous time period in the window of time. The method also includes computing a metric value for the entity based upon the time-series data, where the metric value is indicative of suitability of the behavioral data for provision to a computer-executable model, and further where the computer-executable model is trained to identify anomalous behavior of the entity. The method further includes providing the behavioral data to the computer-executable model based upon the metric value, where the computer-executable model generates an output based upon the behavioral data, and further where the output indicates whether the behavioral data is anomalous relative to previously observed behavior of the entity.

(B2) In some embodiments of the method of (B1), the computer-executable entity is one of a virtual machine or a container.

(B3) In some embodiments of the method of at least one of (B1)-(B2), the feature comprises names processes that are executable by the computer-executable entity.

(B4) In some embodiments of the method of at least one of (B1)-(B3), the method also includes obtaining second time-series data for the computer-executable entity. The second time-series data includes second values assigned to the time period over the window of time, where a second value assigned to the time period in the time periods is indicative of a number of second processes that were executed with respect to a second feature of the entity during the time period that were not executed in any previous time period during the window of time, where the metric value for the entity is computed based further upon the second time-series data.

(B5) In some embodiments of the method of at least one of (B1)-(B4), the behavioral data includes an identity of a process executed by the entity in a most recent time period. The behavioral data also includes a count value that indicates a number of times that the process was executed by the entity in the most recent time period.

(B6) In some embodiments of the method of at least one of (B1)-(B5), the method also includes comparing the metric value with a threshold, where the behavioral data is provided to the computer-executable model based upon the metric value being above the threshold.

(B7) In some embodiments of the method of at least one of (B1)-(B6), computing the metric value includes computing a confidence value for the feature, where the confidence value is indicative of a confidence that a next value for a next time period in the window of time is able to be accurately predicted, where the metric value is based upon the confidence value.

(B8) In some embodiments of the method of at least one of (B1)-(B7), computing the metric value includes computing a trend value for the time-series data based upon the values assigned to the time periods, where the metric value is based upon the trend value.

(B9) In some embodiments of the method of at least one of (B1)-(B8), the method further includes obtaining an importance value for the feature, where the importance value for the feature is based upon a weight assigned to the feature by the computer-executable model, and further where the metric is computed based upon the importance value.

(B10) In some embodiments of the method of at least one of (B1)-(B9), the method also includes computing a second metric value for the entity based upon the time-series data, where the second matric value is indicative of applicability of a second computer-executable model with respect to the behavioral data, and further where the second computer-executable model is trained to identify anomalous behavior of the entity. The method further includes refraining from providing the behavioral data to the second computer-executable model based upon the second metric value.

(B11) In some embodiments of the method of at least one of (B1)-(B10), the entity includes multiple virtual machines corresponding to a customer of the cloud computing system.

(C1) In another aspect, a computing system includes a processor and memory, where the memory stores instructions that, when executed by the processor, cause the processor to perform any of the methods described herein (e.g., any of (A1)-(A8) or (B1)-(B11)).

(D1) In yet another aspect, a computer-readable storage medium includes instructions that, when executed by a processor, cause the processor to perform any of the methods described herein (e.g., any of (A1)-(A8) or (B1)-(B11)).

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computing system comprising:
a processor; and
memory storing instructions that, when executed by the processor, cause the processor to perform acts comprising:
obtaining time-series data for a computer-executable entity that is being executed in a cloud computing environment, where the time-series data is based upon behavioral data for the entity, and further where the time-series data comprises:
values assigned to time periods over a window of time, where a value assigned to a time period in the time periods is indicative of a number of processes that were executed by or on behalf of the computer-executable entity with respect to a feature during the time period that were not executed in any previous time period in the window of time;
computing a metric value for the entity based upon the time-series data, where the metric value is indicative of suitability of the behavioral data for provision to a computer-executable model, and further where the computer-executable model is trained to identify anomalous behavior of the entity; and
based upon the metric value, providing the behavioral data to the computer-executable model, where the computer-executable model generates an output based upon the behavioral data, and further where the output indicates whether the behavioral data is anomalous relative to previously observed behavior of the entity.

2. The computing system of claim 1, where the computer-executable entity is one of a virtual machine or a container.

3. The computing system of claim 1, where the feature comprises names processes that are executable by the computer-executable entity.

4. The computing system of claim 1, the acts further comprising:
obtaining second time-series data for the computer-executable entity, where the second time-series data comprises:
second values assigned to the time period over the window of time, where a second value assigned to the time period in the time periods is indicative of a number of second processes that were executed with respect to a second feature of the entity during the time period that were not executed in any previous time period during the window of time, where the metric value for the entity is computed based further upon the second time-series data.

5. The computing system of claim 1, where the behavioral data comprises:
an identity of a process executed by the entity in a most recent time period; and
a count value that indicates a number of times that the process was executed by the entity in the most recent time period.

6. The computing system of claim 1, the acts further comprising:
comparing the metric value with a threshold, where the behavioral data is provided to the computer-executable model based upon the metric value being above the threshold.

7. The computing system of claim 1, where computing the metric value comprises:
computing a confidence value for the feature, where the confidence value is indicative of a confidence that a next value for a next time period in the window of time is able to be accurately predicted, where the metric value is based upon the confidence value.

8. The computing system of claim 1, where computing the metric value comprises:
computing a trend value for the time-series data based upon the values assigned to the time periods, where the metric value is based upon the trend value.

9. The computing system of claim 1, the acts further comprising:
obtaining an importance value for the feature, where the importance value for the feature is based upon a weight assigned to the feature by the computer-executable model, and further where the metric is computed based upon the importance value.

10. The computing system of claim 1, the acts further comprising:
computing a second metric value for the entity based upon the time-series data, where the second matric value is indicative of applicability of a second computer-executable model with respect to the behavioral data, and further where the second computer-executable model is trained to identify anomalous behavior of the entity; and
based upon the second metric value, refraining from providing the behavioral data to the second computer-executable model.

11. The computing system of claim 1, where the entity comprises multiple virtual machines corresponding to a customer of the cloud computing system.

12. A method for determining whether to provide data to a computer-executable model that is trained to identify anomalies in data corresponding to an entity that is executing in a cloud computing environment, the method comprising:
obtaining time-series data for a feature of the entity, where the feature comprises multiple processes that are executable by the entity, and further where the time-series data comprises:
values assigned to time periods within a time window, where a value in the values is representative of a number of processes in the processes that were executed by the entity a first time within the time window;
computing a likelihood that a next value in the time-series data for a next time period following the time window is able to be correctly predicted, where the likelihood is computed based upon the values assigned to the time periods;
providing the data corresponding to the entity to the computer-executable model based upon the likelihood, where the computer-executable model generates an output based upon the data, and further where an alert is transmitted to a computing device associated with the entity based upon the output of the computer-executable model.

13. The method of claim 12, where the alert indicates that the data corresponding to the entity includes an anomaly.

14. The method of claim 12, further comprising:
computing a trend value based upon the values assigned to the time periods within the time window, where the data corresponding to the entity is provided to the computer-executable model based further upon the trend value.

15. The method of claim 12, where the computer-executable entity is a virtual machine executing in the cloud computing environment.

16. The method of claim 12, where the computer-executable entity is a container executing in the cloud computing environment.

17. The method of claim 12, further comprising:
obtaining second time-series data for a second feature of the entity, where the second feature comprises second multiple processes that are executed by the entity, and further where the second time-series data comprises:
second values assigned to the time periods within the time window, where a second value in the second values is representative of a second number of second processes in the multiple second processes that were executed by the entity a first time within the time window, where the data corresponding to the entity is provided to the computer-executable model based upon the second time-series data.

18. The method of claim 17, further comprising:
computing a second likelihood that a next value in the second time-series data for the next time period following the time window is able to be correctly predicted, where the second likelihood is computed based upon the second values assigned to the time periods, and further where the data corresponding to the entity is provided to the computer-executable model based upon the second likelihood.

19. The method of claim 12, further comprising obtaining an importance value for the feature, where the importance value for the feature is indicative of a weight assigned to the feature by the computer-executable model, and further where the data corresponding to the entity is provided to the computer-executable model based upon the importance value.

20. A computer-readable storage medium comprising instructions that, when executed by a processor, cause the processor to perform acts comprising:
obtaining time-series data for a computer-executable entity that is being executed in a cloud computing environment, where the time-series data comprises:
values assigned to time periods over a window of time, where a value assigned to a time period in the time periods is indicative of a number of processes that were executed with respect to a feature of the entity during the time period that were not executed in any previous time period in the window of time;
computing a metric value for the entity based upon the time-series data, where the metric value is indicative of applicability of a computer-executable model with respect to data corresponding to the entity in a most recent period of time in the periods of time, and further where the computer-executable model is trained to identify anomalies in the data corresponding to the entity; and
based upon the metric value, providing the data corresponding to the entity to the computer-executable model, where the computer-executable model generates an output that indicates whether the data includes an anomaly based upon the data corresponding to the entity.
